(19) United States
(12) Patent Application Publication
(10) Pub. No.: US 2025/0224008 A1
(43) Pub. Date: Jul. 10, 2025

(54) BRAKE DISC

(71) Applicant: Brembo S.p.A., Curno, Bergamo (IT)

(72) Inventors: Simone BIONDO, Curno, Bergamo (IT); Michele DONATI, Curno, Bergamo (IT)

(21) Appl. No.: 18/852,538

(22) PCT Filed: Mar. 29, 2023
(86) PCT No.: PCT/IB2023/053115

§ 371 Date: Sep. 30, 2024

(30) Foreign Application Priority Data
Mar. 30, 2022 (IT) 102022000006224

(51) Int. Cl. F16D 65/12; F16D 65/02

(52) U.S. Cl. CPC F16D 65/123; F16D 65/128; F16D 2065/132; F16D 2065/1328; F16D 2065/1364; F16D 2200/0004; F16D 2250/0023

(57) ABSTRACT

The present invention relates to a brake disc (1) comprising a bell (2) having a bell base (3) and a tubular wall (4) protruding axially (A-A) from said bell base (3), said brake disc (1) further comprising a braking band (5) having a band opening (6), wherein the tubular wall (4) of said bell (2) comprises a cup toothing system (7) extending along an outer circumference of said tubular wall (4) and having cup teeth (8) protruding outwards in a radial direction (R-R), said cup teeth (8) are circumferentially (C-C) spaced out by empty cup gaps (9), wherein each empty cup gap (9) is in the circumferential direction (C-C) between adjacent cup teeth (8), the braking band (5) comprises a ring toothing system (10) having an annular ring body (11) from which ring teeth (12) radially inwardly protruding at the band opening (6) extend, wherein said ring teeth (12) are circumferentially (C-C) spaced out by ring tooth gaps (13), wherein each ring tooth gap (13) is in the circumferential direction (C-C) between ring teeth (12); and wherein the cup toothing system (7) and the ring toothing system (10) mutually mesh, and wherein said braking band (5) is a ventilated braking band comprising a first wheel-side band plate (14) and a second vehicle-side band plate (15) mutually facing and spaced apart by a ventilation duct (16) and mutually connected by plate connecting elements (17); and wherein said annular ring body (11) of said ring toothing system (10) at least partially faces said ventilation duct (16) forming at least one annular channel (18) at the base of said first or second plate (14, 15) delimited by said tubular wall (4) of said bell (2) at least on one side thereof.

### FIELD OF THE INVENTION

The present invention relates to braking devices comprising brake discs suited to vehicles.

In particular, the present invention relates to a brake disc comprising a bell and a braking band coupled together with a toothing.

### BACKGROUND ART

In a disc brake, the brake caliper is generally arranged straddling the outer peripheral margin of a brake disc, adapted to rotate about a rotation axis (A-A) defining an axial direction (X-X). In a disc brake, a radial direction (R-R), substantially orthogonal to said axial direction (X-X), and a tangential (C-C) or circumferential (C-C) direction, orthogonal to both said axial direction (X-X) and said radial direction (R-R), are further defined.

Brake calipers are constrained to a support structure, which remains stationary with respect to the vehicle wheel, such as a stub axle of a vehicle suspension or a vehicle wheel hub or a fork, for example. The brake caliper usually comprises a caliper body having two elongated portions arranged so as to face opposite braking surfaces of a brake disc, and at least one bridge connecting said two elongated portions together. Suitably actuated calipers press the pads against the braking band and the braking action is produced by the friction between the pads and the braking band of the brake disc.

Brake discs are known, in which the bell is made of a different material from that of the braking band, and in particular bells made of a deformed and cup-shaped steel sheet and provided with a circumferential toothing to be coupled to the braking band.

Such brake discs, which can be referred to as composite, allow a lower weight, for example, and thus help reduce the weight of the unsprung masses of the related vehicle.

A brake disc of this type is known, for example, from DE102009012217 and EP2850333A1.

Other similar solutions are known from DE102009012216, US 2014000995, US2014311838, EP2404075A1, DE102012022775A1.

In this case, the braking band and the bell each have teeth, these teeth being in mutual engagement to allow the torque transmission between the braking band and the bell. To also ensure the axial attachment between the braking band and the bell, the bell has retaining elements which are directed radially outwards on an upper edge and rest against a corresponding surface of the braking band.

Preferably, the braking bands are ventilated in order to dissipate the heat developed during the braking action.

The drawback of such a solution is that such an axial attachment between the braking band and the bell occurs at one of the two plates of the braking band.

In particular, the braking band toothing is made on the lower edge of the braking band plate facing the vehicle wheel so as to minimize the axial extension of the tubular portion of the bell and facilitate the ingress of cooling air from the central opening of the braking band.

However, these known solutions have a non-ideal mass distribution to resist and minimize the thermal distortions generated by the heating of the braking band. Indeed, the constraint of the bell to the plate facing the wheel leads to a dissymmetric thermal expansion of the braking band, which, in the case of high overheating, results in a significant departure from the ideal braking plane of the braking surfaces delimiting the exterior of the plates.

### SOLUTION

Therefore, it is the object of the present invention to provide a disc brake disc having a toothed connection between a bell and a braking band and minimizing the axial mass distribution of the connection portion displaced with respect to the centerline plane of the braking band, thus reducing the thermal distortions of the brake disc.

This and other objects and advantages are achieved by a brake disc according to claim 1.

Some advantageous embodiments are the subject of the dependent claims.

The analysis of this solution showed how the suggested solution allows obtaining a brake disc in which the non-ideal mass distribution is minimized in order to resist and minimize the thermal distortions generated by the heating of the braking band without simultaneously compromising the ventilation and especially a heat exchange between the braking band and the cooling air.

### DRAWINGS

Further features and advantages of the device, the disc brake, and the vehicle will become apparent from the following description of preferred embodiments thereof, given by way of non-limiting indication, with reference to the accompanying drawings, in which:

FIG. 1 shows an axonometric view of a brake disc from the wheel side;

FIG. 2 is an axonometric view of the disc in FIG. 1 from the vehicle side;

FIG. 3 shows an axonometric view with parts separated of the braking band and the disc bell in FIG. 1 from the wheel side;

FIG. 4 is an axonometric view of a detail of the braking band in FIG. 3;

FIG. 5 is an axonometric view of a detail of the bell in FIG. 3;

FIG. 6 shows an axonometric view with parts separated of the braking band and the disc bell in FIG. 1 from the vehicle side;

FIG. 7 is an axonometric view of a detail of the braking band in FIG. 6;

FIG. 8 shows a detail of a section view in a radial and axial plane of the disc in FIG. 1;

FIG. 9 is an enlargement of the coupling between the bell and the braking band in the section view in FIG. 8.

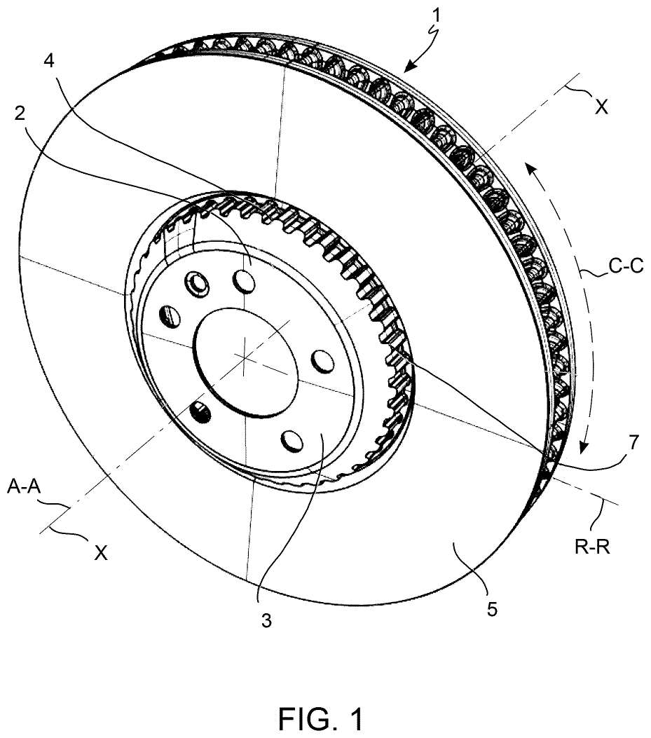

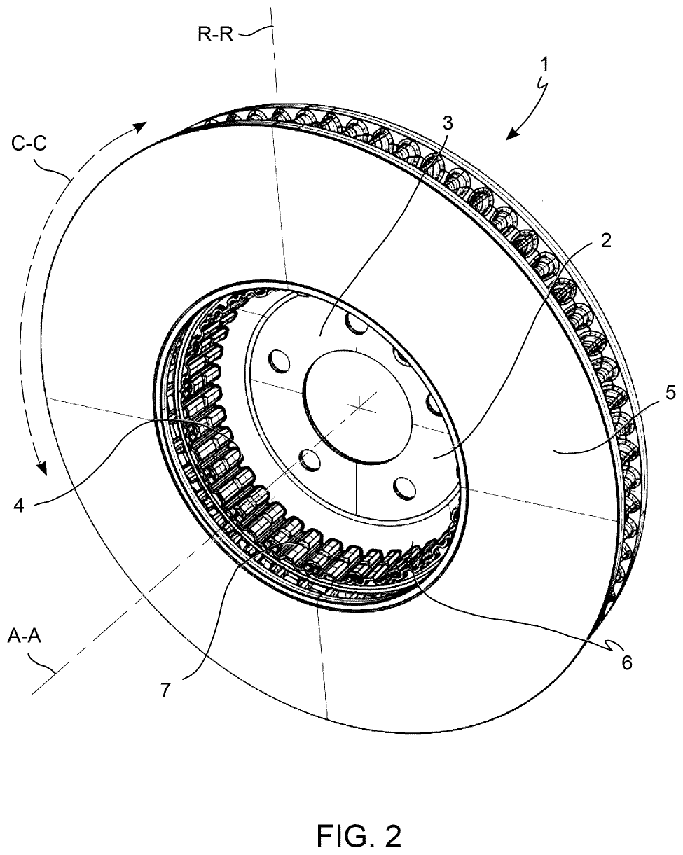

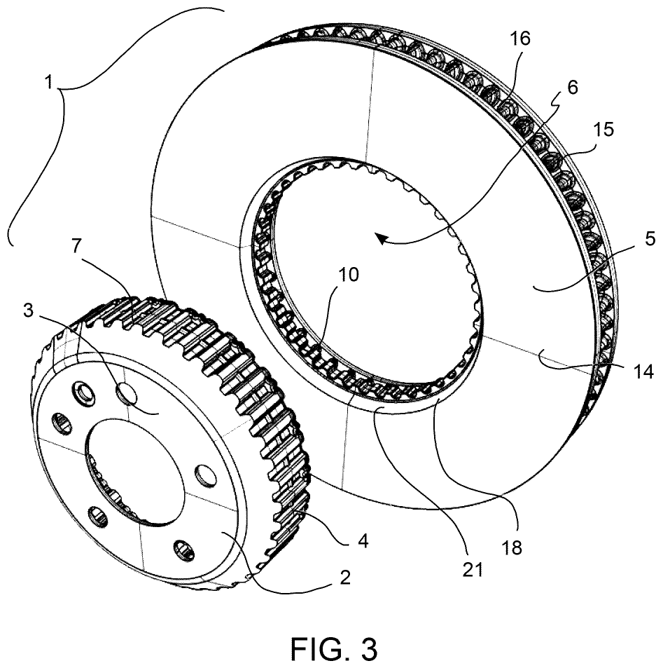

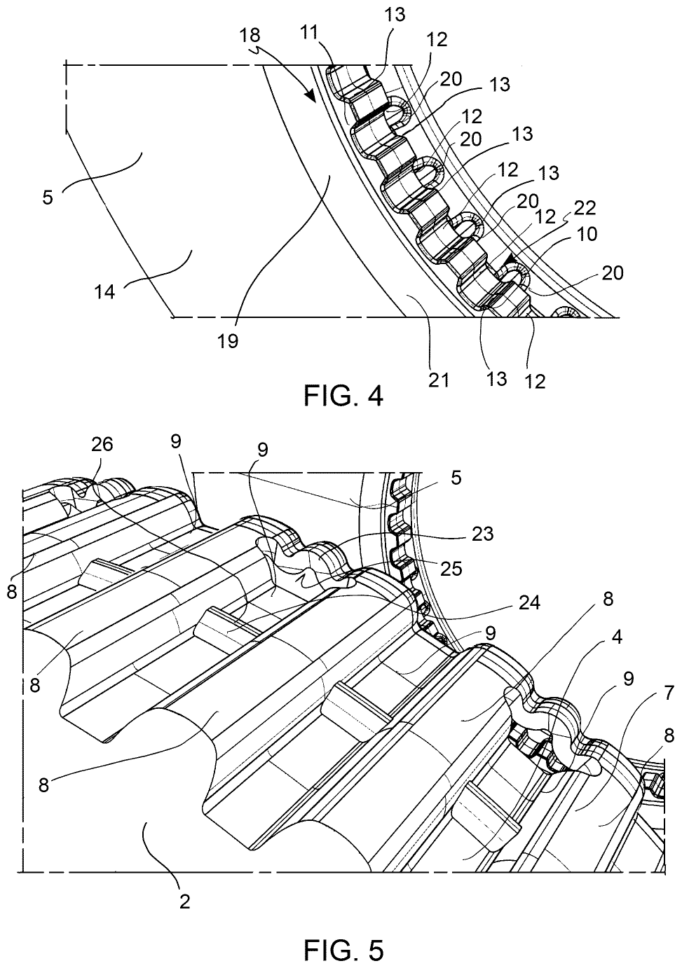

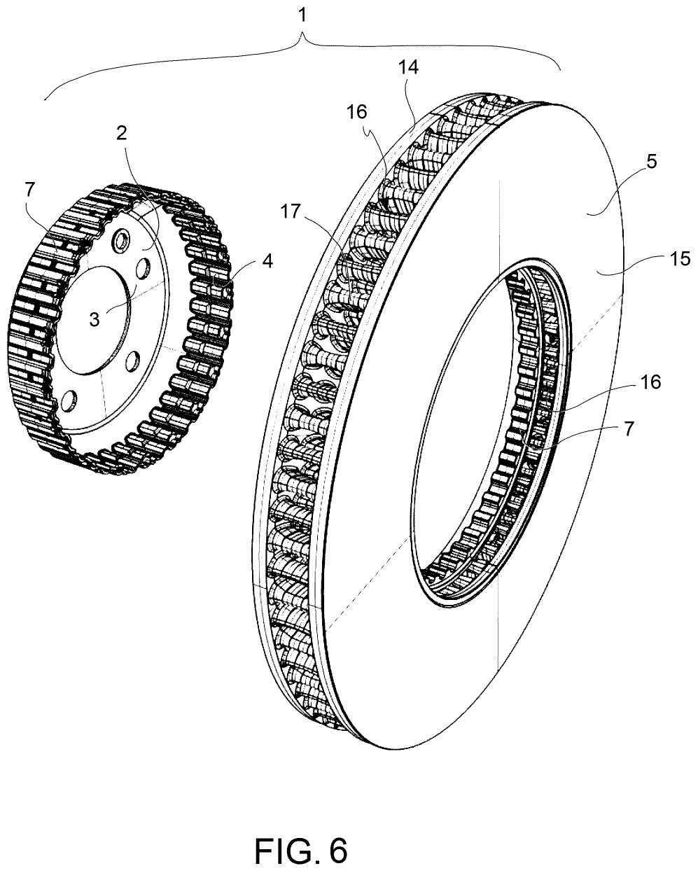

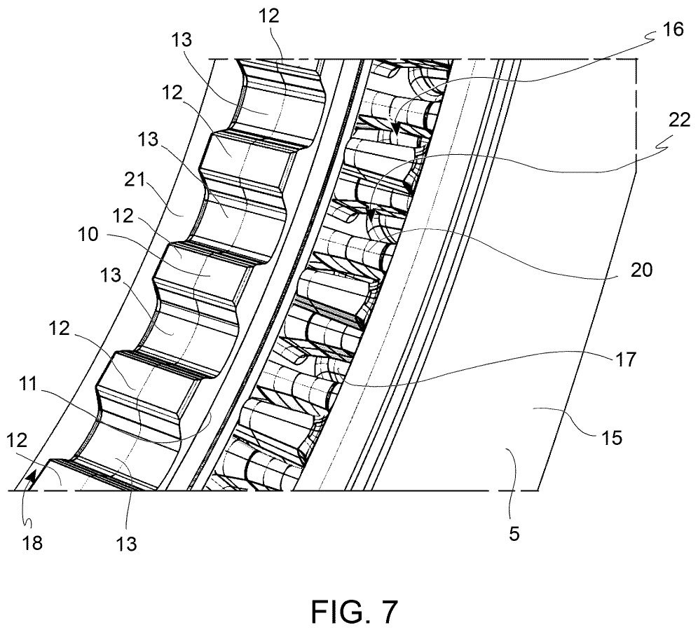

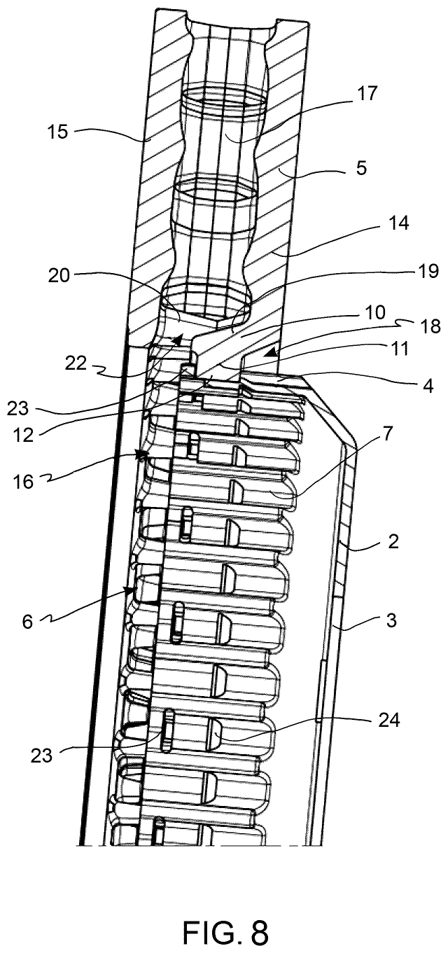

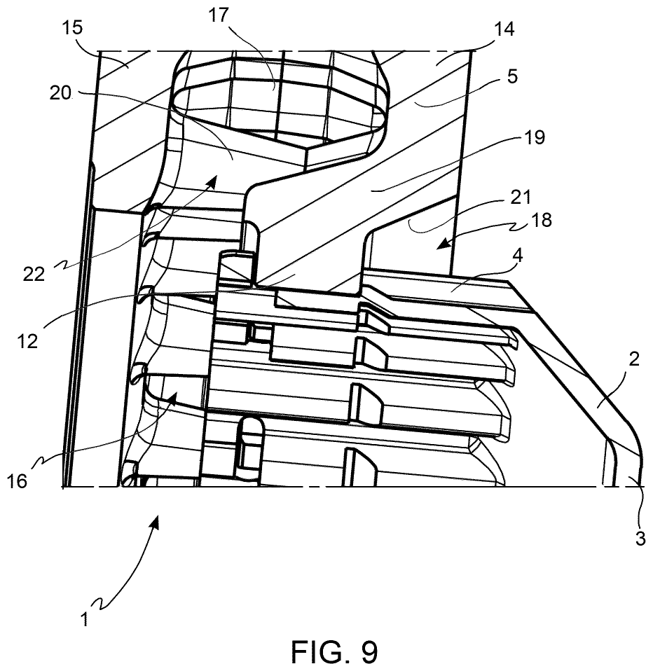

### DESCRIPTION OF SOME PREFERRED EMBODIMENTS

According to a general embodiment, a disc brake 1 comprises a braking band 2. The bell 2 comprises a bell base 3, e.g., disc-shaped, and a tubular wall 4. The tubular wall 4 protrudes axially A-A from said bell base 3.

Said brake disc 1 further comprises a braking band 5 centrally having a band opening 6.

The tubular wall 4 of said bell 2 comprises a cup toothing system 7 extending along a circumference outside said tubular wall 4. Said cup toothing 7 comprises cup teeth 8 protruding outwards in the radial direction R-R.

According to an embodiment, the tubular wall 4 of said bell 2 forms in one piece a cup toothing system 7 extending along a circumference outside said tubular wall 4 and comprising cup teeth 8 protruding outwards in a radial direction R-R.

Said cup teeth 8 are circumferentially C-C spaced out by an empty cup gap 9, where each empty cup gap 9 is in the circumferential direction C-C between adjacent cup teeth 8.

The braking band 5 further comprises a ring toothing system 10 having an annular ring body 11 from which ring teeth 12 radially inwardly protruding at the band opening 6 extend.

According to an embodiment, the braking band 5 forms in one piece a ring toothing system 10 having an annular ring body 11 from which ring teeth 12 radially inwardly protruding at the band opening 6 extend.

Said ring teeth 12 are circumferentially C-C spaced out by a ring tooth gap 13, where each ring tooth gap 13 is in the circumferential direction C-C between ring teeth 12.

The cup toothing system 7 and the ring toothing system 10 mutually mesh.

According to an embodiment, the cup toothing system 7 and the ring toothing system 10 mutually mesh and are intimately coupled together.

Said braking band 5 is a ventilated braking band comprising a first wheel-side band plate 14 and a second vehicle-side band plate 15 mutually facing and spaced apart by a ventilation duct 16 and mutually connected by plate connecting elements 17.

Advantageously, said annular ring body 11 of said ring toothing system 10 at least partially faces said ventilation duct 16 forming at least one annular channel 18 at the base of said first or second plate 14, 15 delimited by said tubular wall 4 of said bell 2 at least on one side thereof.

According to an embodiment, said annular ring body 11 is a single body which is continuous in the circumferential direction C-C.

According to an embodiment, said annular ring body 11 is connected to one of said first or second plate 14, 15 by at least one inclined connecting element 19 forming said annular channel 18 at the base of said first or second plate 14, 15.

According to an embodiment, said annular ring body 11 is a single body which is continuous in the circumferential direction C-C.

Said annular ring body 11 is connected to one of said first or second plate 14, 15 by at least one inclined connecting element 19 forming said annular channel 18 at the base of said first or second plate 14, 15.

According to an embodiment, said annular ring body 11 is connected to one of said first or second plates 14, 15 by at least one circumferentially continuous inclined connecting element 19.

According to an embodiment, said annular ring body 11 comprises a flared ring wall 21 facing said tubular wall 4 of said bell 2.

According to an embodiment, said annular ring body 11 comprises a flared ring wall 21 facing said tubular wall 4 of said bell 2 and where said flared ring wall 21 is frustoconical in shape.

According to an embodiment, said annular ring body 11 is discontinuously connected to an opposite plate 15, 14 with respect to said first or second plate 14, 15.

According to an embodiment, said annular ring body 11 is discontinuously connected to an opposite plate 15, 14 with respect to said first or second plate 14, 15 by a plurality of ring column elements 20 mainly extending in the axial direction A-A.

According to an embodiment, said annular ring body 11 is discontinuously connected to an opposite plate 15, 14 with respect to said first or second plate 14, 15 by a plurality of ring column elements 20 mainly extending in the axial direction A-A, where each ring column element connects close to the inner radial end of said opposite plate 15, 14 remaining within said ventilation duct 16.

According to an embodiment, said annular ring body 11 is discontinuously connected to an opposite plate 15, 14 with respect to said first or second plate 14, 15 by a plurality of ring column elements 20 mainly extending in the axial direction A-A and where said ring column elements 20 are enlarged at the ends thereof and tapered towards a smaller portion located between said ends.

According to an embodiment, said annular ring body 11 is discontinuously connected to an opposite plate 15, 14 with respect to said first or second plate 14, 15 by a plurality of ring column elements 20 mainly extending in the axial direction A-A and where ventilation openings 22 are formed between the ring column elements 20, which put said band opening 6 in communication with said ventilation duct 16.

According to an embodiment, at least one of said cup teeth 8 or at least one tubular wall portion 4 of said bell 2 delimiting said empty cup gap 9 comprises at least one radial cup deformation 23 or radial and circumferential cup deformations 24 forming at least one axial abutment 25 which delimits, at least in one direction, the displacement in the axial direction A-A of at least one ring tooth 12.

According to an embodiment, at least one of said cup teeth 8 or at least one tubular wall portion 4 of said bell 2 delimiting said empty cup gap 9 comprises at least one pair of radial cup deformations 23 or radial and circumferential cup deformations 24 forming at least two opposing axial abutments 25 which delimit, in opposite directions, the displacement in the axial direction A-A of at least one ring tooth 12.

According to an embodiment, said bell 2 is obtained from at least one deformed and shaped sheet metal.

In order to meet specific, contingent needs, those skilled in the art may make several changes and adaptations to the above-described embodiments and may replace elements with others which are functionally equivalent, without however departing from the scope of the following claims.

### LIST OF REFERENCE SIGNS

1 brake disc
2 bell
3 bell base
4 tubular wall
5 braking band
6 band opening
7 cup toothing system
8 cup teeth
9 empty cup gap
10 ring toothing system
11 annular ring body
12 ring teeth
13 ring tooth space
14 first wheel-side band plate
15 second vehicle-side band plate
16 ventilation duct
17 plate connecting elements
18 annular canal
19 inclined connecting element
20 ring column element
21 flared ring wall
22 ventilation openings
23 radial cup deformations
24 radial and circumferential cup deformations
25 axial abutment
26 axial abutment
A-A axial direction
R-R radial direction
C-C circumferential direction
X-x disc axis of disc brake

1-10. (canceled)

11. A brake disc comprising a bell having a bell base and a tubular wall protruding axially from said bell base, said brake disc further comprising a braking band having a band opening, wherein
the tubular wall of said bell comprises a cup toothing system extending along an outer circumference of said tubular wall and having cup teeth protruding outwardly in a radial direction,
said cup teeth are circumferentially spaced by empty cup gaps, wherein each empty cup gap is located in the circumferential direction between adjacent cup teeth,
the braking band comprises a ring toothing system having an annular ring body from which ring teeth radially protrude inwardly at the band opening,
wherein said ring teeth are circumferentially spaced by ring tooth gaps, wherein each ring tooth gap is located in the circumferential direction between ring teeth;
and wherein the cup toothing system and the ring toothing system are mutually meshing,
and wherein said braking band is a ventilated braking band comprising a first wheel-side band plate and a second vehicle-side band plate mutually facing and spaced apart by a ventilation duct and mutually connected by plate connecting elements;
characterized in that
said annular ring body of said ring toothing system is at least partially facing said ventilation duct forming at least one annular channel at the base of said first or second plate delimited by said tubular wall of said bell at least on one side thereof.

12. A brake disc, according to claim 11, wherein
said annular ring body is a single continuous body in the circumferential direction; or wherein
said annular ring body is connected to one of said first or second plate by at least one inclined connecting element which forms said annular channel at the base of said first or second plate;
or wherein
said annular ring body is a single continuous body in the circumferential direction; and wherein
said annular ring body is connected to one of said first or second plate by at least one inclined connecting element which forms said annular channel at the base of said first or second plate.

13. A brake disc, according to claim 11, wherein
said annular ring body is connected to one of said first or second plates by at least one circumferentially continuous inclined connecting element;
or wherein
said annular ring body comprises a flared ring wall facing said tubular wall of said bell.

14. A brake disc according to claim 11, wherein
said annular ring body comprises a flared ring wall facing said tubular wall of said bell and wherein said flared ring wall is frustoconical.

15. A brake disc according to claim 11, wherein
annular ring body connected in a discontinuous manner to an opposite plate relative to said first or second plate.

16. A brake disc according to claim 11, wherein
annular ring body connected in a discontinuous manner to an opposite plate relative to said first or second plate by means of a plurality of ring column elements which extend mainly in an axial direction;
or wherein
annular ring body connected in a discontinuous manner to an opposite plate relative to said first or second plate by means of a plurality of ring column elements which extend mainly in an axial direction, wherein each ring column element connects near the inner radial end of said opposite plate remaining within said ventilation duct.

17. A brake disc according to claim 11, wherein
annular ring body connected in a discontinuous manner to an opposite plate relative to said first or second plate by means of a plurality of ring column elements which extend mainly in an axial direction and wherein said ring column elements have a shape enlarged at their ends and tapered toward a portion of lesser size located between said ends.

18. A brake disc according to claim 11, wherein
annular ring body connected in a discontinuous manner to an opposite plate relative to said first or second plate by means of a plurality of ring column elements which extend mainly in an axial direction and wherein ventilation openings are formed between ring column elements which connect said band opening with said ventilation duct.

19. A brake disc according to claim 11, wherein
at least one of said cup teeth or at least one tubular wall portion of said bell which delimits said empty cup gap comprises at least one radial cup deformation or radial and circumferential cup deformation which forms at least one axial abutment which delimits the displacement in axial direction of at least one ring tooth at least in one direction;
or wherein
at least one of said cup teeth or at least one tubular wall portion of said bell which delimits said empty cup gap comprises at least one pair of radial cup deformations or radial and circumferential cup deformation which form at least two opposite axial abutments which delimit the displacement in axial direction of at least one ring tooth in opposite directions.

20. A brake disc according to claim 11, wherein
said bell is obtained from at least one deformed and shaped sheet metal.
